(19) United States
(12) Patent Application Publication
(10) Pub. No.: US 2025/0167684 A1
(43) Pub. Date: May 22, 2025

(54) LOAD CONTROL DEVICE FOR A LIGHT-EMITTING DIODE LIGHT SOURCE

(71) Applicant: Lutron Technology Company LLC, Coopersburg, PA (US)

(72) Inventor: Stuart W. DeJonge, Riegelsville, PA (US)

(73) Assignee: Lutron Technology Company LLC, Coopersburg, PA (US)

(21) Appl. No.: 19/030,055

(22) Filed: Jan. 17, 2025

Related U.S. Application Data
(63) Continuation of application No. 18/390,741, filed on Dec. 20, 2023.
Application No. 18/390,741 is a continuation of application No. 17/734,161, filed on May 2, 2022, now Pat. No. 11,888,401.
Application No. 17/734,161 is a continuation of application No. 17/135,037, filed on Dec. 28, 2020, now Pat. No. 11,324,092.
Application No. 17/135,037 is a continuation of application No. 16/526,629, filed on Jul. 30, 2019, now Pat. No. 10,904,979.
(60) Provisional application No. 62/712,109, filed on Jul. 30, 2018.

(51) Int. Cl. H02M 3/335; H05B 45/37

(52) U.S. Cl. CPC H02M 3/33523; H02M 3/33571; H05B 45/37

(57) ABSTRACT

A load control device may utilize a feedback signal representative of an average magnitude of the load current conducted through an electrical load to control the amount of power delivered to the electrical load. The feedback signal may be generated based on a sense signal that is electrically isolated from the line voltage input of the load control device. Depending on the operational characteristics of the electrical load, the feedback signal may be generated using different techniques. In one example technique, the sense signal may be integrated and filtered to derive the feedback signal. In another example technique, the sense signal may be used in conjunction with an input power of the load control device and an efficiency parameter of the load control device to derive the feedback signal. In yet another example technique, values derived from the foregoing two techniques may be blended together to obtain the feedback signal.

### CROSS-REFERENCE TO RELATED APPLICATION

This application is a continuation of U.S. application Ser. No. 18/390,741, filed Dec. 20, 2023; which is a continuation of U.S. application Ser. No. 17/734,161, filed May 2, 2022, now U.S. Pat. No. 11,324,092 issued May 3, 2022; which is a continuation of U.S. application Ser. No. 17/135,037, filed Dec. 28, 2020, now U.S. Pat. No. 11,324,092 issued May 3, 2022; which is a continuation of U.S. application Ser. No. 16/526,629, filed on Jul. 30, 2019, now U.S. Pat. No. 10,904,979 issued Jan. 26, 2021, all of which claim the benefit of Provisional U.S. Patent Application No. 62/712,109, filed Jul. 30, 2018, the disclosures of which are incorporated herein by reference in their entireties.

### BACKGROUND

Light-emitting diode (LED) light sources (e.g., LED light engines) are often used in place of or as replacements for conventional incandescent, fluorescent, or halogen lamps, and the like. LED light sources may comprise a plurality of light-emitting diodes mounted on a single structure and provided in a suitable housing. LED light sources are typically more efficient and provide longer operational lives as compared to incandescent, fluorescent, and halogen lamps. In order to illuminate properly, an LED driver control device (e.g., an LED driver) may be coupled between an alternating-current (AC) source and the LED light source for regulating the power supplied to the LED light source. The LED driver may regulate either the voltage provided to the LED light source to a particular value, the current supplied to the LED light source to a specific peak current value, or may regulate both the current and voltage.

LED light sources are typically rated to be driven via one of two different control techniques: a current load control technique or a voltage load control technique. An LED light source that is rated for the current load control technique is also characterized by a rated current (e.g., approximately 350 milliamps) to which the peak magnitude of the current through the LED light source should be regulated to ensure that the LED light source is illuminated to the appropriate intensity and color. In contrast, an LED light source that is rated for the voltage load control technique is characterized by a rated voltage (e.g., approximately 15 volts) to which the voltage across the LED light source should be regulated to ensure proper operation of the LED light source. Typically, each string of LEDs in an LED light source rated for the voltage load control technique includes a current balance regulation element to ensure that each of the parallel legs has the same impedance so that the same current is drawn in each parallel string.

The light output of an LED light source can be dimmed. Different methods of dimming LEDs include a pulse-width modulation (PWM) technique and a constant current reduction (CCR) technique. Pulse-width modulation dimming can be used for LED light sources that are controlled in either a current or voltage load control mode/technique. In pulse-width modulation dimming, a pulsed signal with a varying duty cycle is supplied to the LED light source. If an LED light source is being controlled using the current load control technique, the peak current supplied to the LED light source is kept constant during an on time of the duty cycle of the pulsed signal. However, as the duty cycle of the pulsed signal varies, the average current supplied to the LED light source also varies, thereby varying the intensity of the light output of the LED light source. If the LED light source is being controlled using the voltage load control technique, the voltage supplied to the LED light source is kept constant during the on time of the duty cycle of the pulsed signal in order to achieve the desired target voltage level, and the duty cycle of the load voltage is varied in order to adjust the intensity of the light output. Constant current reduction dimming is typically only used when an LED light source is being controlled using the current load control technique. In constant current reduction dimming, current is continuously provided to the LED light source, however, the DC magnitude of the current provided to the LED light source is varied to thus adjust the intensity of the light output. Examples of LED drivers are described in greater detail in commonly-assigned U.S. Pat. No. 8,492,987, issued Jul. 23, 2010, and U.S. Patent Application Publication No. 2013/0063047, published Mar. 14, 2013, both entitled LOAD CONTROL DEVICE FOR A LIGHT-EMITTING DIODE LIGHT SOURCE, the entire disclosures of which are hereby incorporated by reference.

### SUMMARY

A load control device is described herein for controlling an amount of power delivered to an electrical load. The load control device may comprise a load regulation circuit, a load sense circuit and a control circuit. The load regulation circuit may be configured to control a magnitude of a load current conducted through the electrical load to control the amount of power delivered to the electrical load across a power range. The load regulation circuit may comprise a transformer and an output inductor located on a secondary side of the transformer. The load regulation circuit may further comprise a winding magnetically coupled to and electrically isolated from the output inductor. The load regulation circuit may be configured to generate a sense signal via the winding and the sense signal may be indicative of a voltage developed across the output inductor. The load sense circuit may be configured to generate, based on the sense signal, a load current feedback signal that indicates a magnitude of the load current conducted through the electrical load. The control circuit may be configured to generate, during at least a first portion of the power range, at least one drive signal based on the load current feedback signal. The at least one drive signal may be used to control the load regulation circuit to adjust an average magnitude of the load current conducted through the electrical load. The load current feedback signal may be generated using different techniques based on the operational characteristics of the electrical load. In one example technique, the sense signal may be integrated and filtered to derive the load current feedback signal. In another example technique, the sense signal may be used in conjunction with an input power of the load control device and an efficiency parameter of the load control device to derive the load current feedback signal. In yet another example technique, values derived from the foregoing two techniques may be blended together to obtain the load current feedback signal.

### BRIEF DESCRIPTION OF THE DRAWINGS

FIG. 1 is a simplified block diagram of an example load control device, such as, a light-emitting diode (LED) driver for controlling the intensity of an LED light source.

FIG. 2 is a simplified schematic diagram of a forward converter and a load sense circuit of an example LED driver.

FIG. 3 is a diagram of simplified waveforms illustrating the operation of the LED driver of FIG. 2 when the forward converter is operating in a continuous mode of operation (e.g., near a high-end intensity).

FIG. 4 is a diagram of simplified waveforms illustrating the operation of the LED driver of FIG. 2 when the forward converter is operating in a discontinuous mode of operation (e.g., near a low-end intensity).

FIGS. 5-7 are simplified example flowcharts of load current measurement procedures that each may be executed by a control circuit of a load control device for determining a magnitude of a load current conducted through an electrical load.

### DETAILED DESCRIPTION

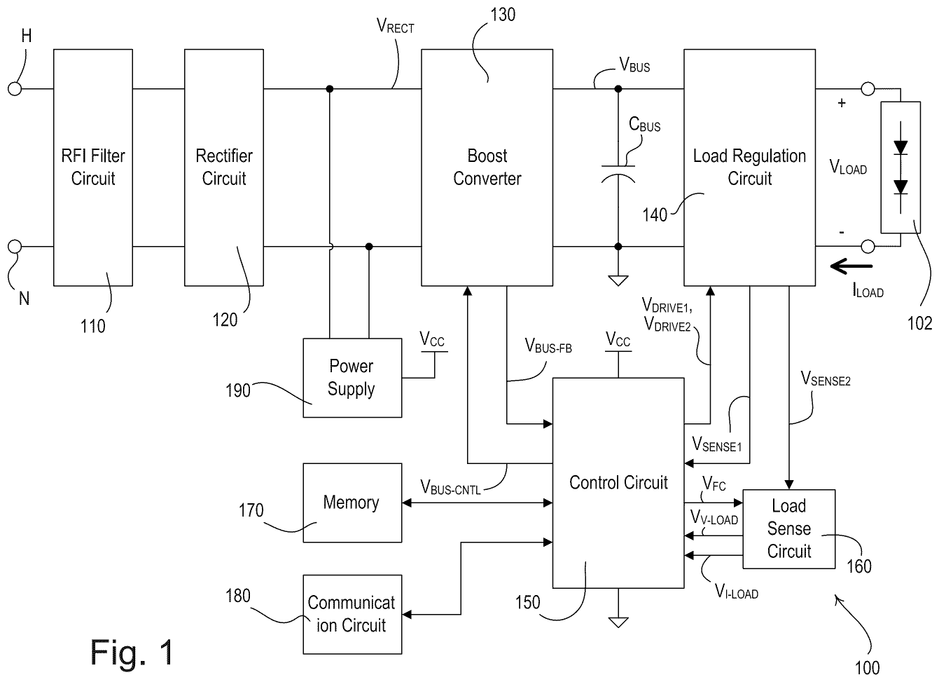

FIG. 1 is a simplified block diagram of an example load control device, e.g., a light-emitting diode (LED) driver 100, for controlling the amount of power delivered to an electrical load, such as, an LED light source 102 (e.g., an LED light engine), and thus the intensity of the light source. The LED light source 102 is shown as a plurality of LEDs connected in series but may comprise a single LED or a plurality of LEDs connected in parallel or a suitable combination thereof, depending on the particular lighting system. The LED light source 102 may comprise one or more organic light-emitting diodes (OLEDs). The LED driver 100 may comprise a hot terminal H and a neutral terminal that are adapted to be coupled to an alternating-current (AC) power source (not shown).

The LED driver 100 may comprise a radio-frequency interference (RFI) filter circuit 110, a rectifier circuit 120, a boost converter 130, a load regulation circuit 140, a control circuit 150, a current sense circuit 160, a memory 170, a communication circuit 180, and/or a power supply 190. The RFI filter circuit 110 may minimize the noise provided on the AC mains. The rectifier circuit 120 may generate a rectified voltage V_{RECT}. The boost converter 130 may receive the rectified voltage V_{RECT} and generate a boosted direct-current (DC) bus voltage V_{BUS} across a bus capacitor C_{BUS}. The boost converter 130 may comprise any suitable power converter circuit for generating an appropriate bus voltage, such as, for example, a flyback converter, a single-ended primary-inductor converter (SEPIC), a Ćuk converter, or other suitable power converter circuit. The boost converter 120 may operate as a power factor correction (PFC) circuit to adjust the power factor of the LED driver 100 towards a power factor of one.

The load regulation circuit 140 may receive the bus voltage V_{BUS} and control the amount of power delivered to the LED light source 102 across a power range. For example, the load regulation circuit may control the intensity of the LED light source 102 between a low-end (e.g., minimum) intensity L_{LE} (e.g., approximately 0.1-5%) and a high-end (e.g., maximum) intensity L_{HE} (e.g., approximately 100%). An example of the load regulation circuit 140 may be an isolated, half-bridge forward converter. An example of the load control device (e.g., LED driver 100) comprising a forward converter is described in greater detail in commonly-assigned U.S. Pat. No. 9,253,829, filed Feb. 2, 2016, entitled LOAD CONTROL DEVICE FOR A LIGHT-EMITTING DIODE LIGHT SOURCE, the entire disclosure of which is hereby incorporated by reference. The load regulation circuit 140 may also comprise, for example, a buck converter, a linear regulator, or any suitable LED drive circuit for adjusting the intensity of the LED light source 102.

The control circuit 150 may be configured to control the operation of the boost converter 130 and/or the load regulation circuit 140. An example of the control circuit 150 may be a controller. The control circuit 150 may comprise, for example, a digital controller or any other suitable processing device, such as, for example, a microcontroller, a programmable logic device (PLD), a microprocessor, an application specific integrated circuit (ASIC), or a field-programmable gate array (FPGA). The control circuit 150 may generate a bus voltage control signal V_{BUS-CNTL}, which may be provided to the boost converter 130 for adjusting the magnitude of the bus voltage V_{BUS}. The control circuit 150 may receive a bus voltage feedback signal V_{BUS-FB} from the boost converter 130, which may indicate the magnitude of the bus voltage V_{BUS}.

The control circuit 150 may generate at least one drive signal such as drive signals V_{DR1}, V_{DR2}. The drive signals V_{DR1}, V_{DR2} may be provided to the load regulation circuit 140 for adjusting the magnitude of a load voltage V_{LOAD} generated across the LED light source 102 and/or the magnitude of a load current I_{LOAD} conducted through the LED light source 120, for example, to control the intensity of the LED light source 120 to a target intensity L_{TRGT}, which may range from the low-end intensity L_{LE} to the high-end intensity L_{HE}. The control circuit 150 may adjust an operating frequency fop and/or a duty cycle DC_{INV} (e.g., an on time T_{ON}) of the drive signals V_{DR1}, V_{DR2} to adjust the magnitude of the load voltage V_{LOAD} and/or the load current I_{LOAD}. Near the high-end intensity L_{HE}, the load regulation circuit 140 may operate in a continuous mode of operation (e.g., as will be described in greater detail below). Near the low-end intensity L_{LE}, the load regulation circuit 140 may operate in a discontinuous mode of operation (e.g., as will be described in greater detail below).

The control circuit 150 may receive one or more sense signals from the load regulation circuit 140. For example, the load regulation circuit 140 may generate first and second sense signals V_{SENSE1}, V_{SENSE2}. The control circuit 150 may receive the first sense signal V_{SENSE1} from the load regulation circuit 140 and may be configured to determine an input power P_{IN} of the load regulation circuit 140 in response to the bus voltage feedback signal V_{BUS-FB} and the first sense signal V_{SENSE1}. The LED driver 100 may also comprise a load sense circuit 160 that receives the second sense signal V_{SENSE2} and generates a load voltage feedback signal V_{V-LOAD} and/or a load current feedback signal V_{I-LOAD}. The load voltage feedback signal V_{V-LOAD} may have a magnitude representative of a magnitude of the load voltage V_{LOAD} while the load current feedback signal V_{I-LOAD} may have a magnitude representative of an average magnitude I_{AVE} of the load current I_{LOAD}. The control circuit 150 may generate a filter control signal V_{FC} for controlling the load sense circuit 160 (e.g., for controlling a portion of the load sense circuit 160). For example, the control circuit 150 may use the filter control signal V_{FC} to control the generation of the load current feedback signal V_{I-LOAD}. The control circuit 150 may be configured to receive the load voltage feedback signal V_{V-LOAD} and/or the load current feedback signal V_{I-LOAD}.

The control circuit 150 may control the drive signals V_{DR1}, V_{DR2} to adjust the magnitude of the load current I_{LOAD} to a target load current I_{TRGT} to thus control the amount of power delivered to the electrical load to a target power level (e.g., to control the intensity of the LED light source 102 to the target intensity L_{TRGT}) in response to the first sense signal V_{SENSE1}, the voltage feedback signal V_{V-LOAD}, and/or the load current feedback signal V_{I-LOAD} (e.g., using a control loop). The control circuit may be configured to determine the average magnitude I_{AVE} of the load current I_{LOAD} using different techniques, for example, based on where the target power level falls within the power range of the lighting source 120 (e.g., based on where the target intensity L_{TRGT} falls within the intensity range of the LED light source 120). When the target power level is greater than a first power threshold (e.g., when the target intensity L_{TRGT} is greater than a first threshold intensity L_{TH1} such as a high threshold intensity, which may be approximately 60%), the control circuit 150 may be configured to determine the average magnitude I_{AVE} of the load current I_{LOAD} using a first load current measurement technique. For example, when using the first load current measurement technique, the control circuit 150 may calculate the average magnitude I_{AVE} of the load current I_{LOAD} using the input power P_{IN} of the load regulation circuit 140, the magnitude of the load voltage V_{LOAD} (e.g., as determined from the load voltage feedback signal V_{V-LOAD}), and an efficiency η (e.g., a predetermined efficiency parameter) of the load regulation circuit 140. When the target power level is less than a second power threshold (e.g., when the target intensity L_{TRGT} is less than a second threshold intensity L_{TH2} such as a low threshold intensity, which may be approximately 40%), the control circuit 150 may be configured to determine the average magnitude I_{AVE} of the load current I_{LOAD} using a second load current measurement technique. For example, when using the second load current measurement technique, the control circuit 150 may determine the average magnitude I_{AVE} of the load current I_{LOAD} from the load current feedback signal V_{I-LOAD}.

When the target power level is less than or equal to the first power threshold and greater than or equal to the second power threshold (e.g., when the target intensity L_{TRGT} is between the first threshold intensity L_{TH1} and the second threshold intensity L_{TH2}), the control circuit 150 may be configured to use both of the first and second load current measurement techniques to determine the average magnitude I_{AVE} of the load current I_{LOAD}. For example, the control circuit 150 may be configured to appropriately mix the average magnitude I_{AVE} of the load current I_{LOAD} determined using the first measurement technique and the average magnitude I_{AVE} of the load current I_{LOAD} determined using the second load current measurement technique to determine the average magnitude I_{AVE} of the load current I_{LOAD} (e.g., as will be described in greater detail below). The load regulation circuit 140 may transition between the continuous and discontinuous modes of operation at an intensity that is greater than the first threshold intensity L_{TH1} to prevent the control circuit 150 from using the second load current measurement technique to determine the average magnitude I_{AVE} of the load current I_{LOAD} when the load regulation circuit is operating in the continuous mode.

The control circuit 150 may be coupled to the memory 170. The memory 170 may store operational characteristics of the LED driver 100 (e.g., the target intensity L_{TRGT}, the low-end intensity L_{LE}, the high-end intensity L_{HE}, etc.). The communication circuit 180 may be coupled to, for example, a wired communication link or a wireless communication link, such as a radio-frequency (RF) communication link or an infrared (IR) communication link. The control circuit 150 may be configured to update the target intensity L_{TRGT} of the LED light source 102 and/or the operational characteristics stored in the memory 170 in response to messages (e.g., digital messages) received via the communication circuit 180. The LED driver 100 may be configured to receive a phase-control signal from a dimmer switch for determining the target intensity L_{TRGT} for the LED light source 102. The power supply 190 may receive the rectified voltage V_{RECT} and generate a direct-current (DC) supply voltage V_{CC} for powering the circuitry of the LED driver 100.

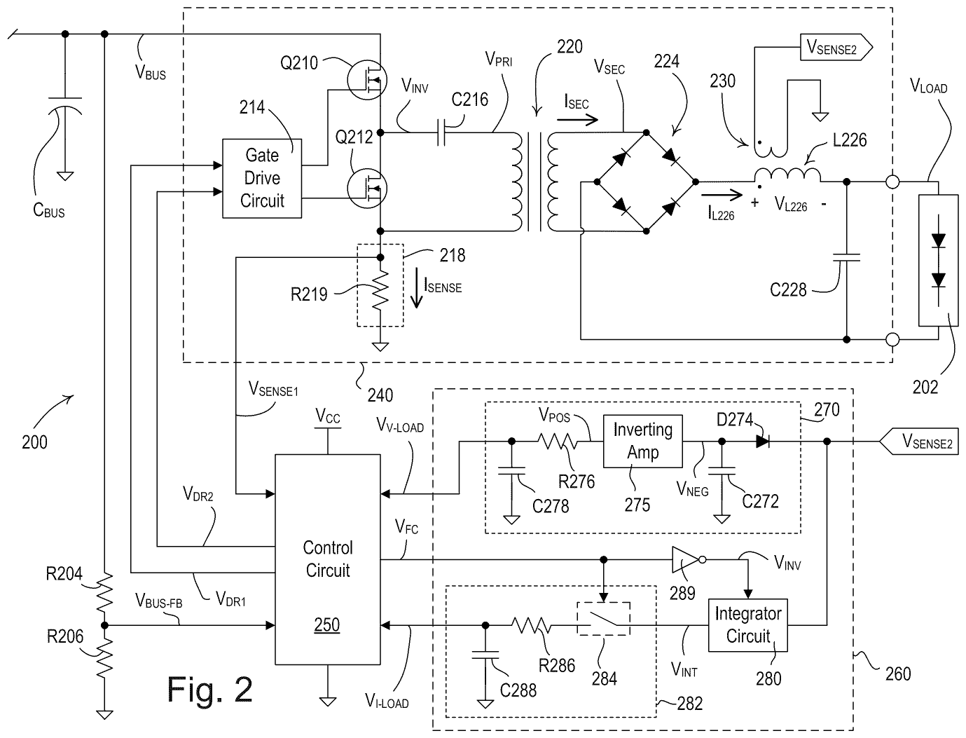

FIG. 2 is a simplified schematic diagram of a forward converter 240 (e.g., the load regulation circuit 140) and a load sense circuit 260 (e.g., the current sense circuit 160) of an example LED driver 200 (e.g., the LED driver 100 shown in FIG. 1). The LED driver 200 may also comprise a control circuit 250 for controlling the forward converter 240 to adjust a present intensity L_{PRES} of an LED light source 202 in response to the load sense circuit 260. The control circuit 250 may receive a bus voltage feedback signal V_{BUS-FB} that may indicate a magnitude of a bus voltage V_{BUS} received by the forward converter 240. For example, the bus voltage feedback signal V_{BUS-FB} may be generated by a resistive divider including resistors R204, R206.

As shown in FIG. 2, the forward converter 240 may comprise a half-bridge inverter circuit including two field effect transistors (FETs) Q210, Q212 for generating a high-frequency inverter voltage V_{INV} from the bus voltage V_{BUS}. The control circuit 250 may generate at least one drive signal (e.g., drive signals V_{DR1}, V_{DR2}) for rendering the FETs Q210, Q212 conductive and non-conductive. The drive signals V_{DR1}, V_{DR2} may be coupled to gates of the respective FETs Q210, Q212 via a gate drive circuit 214 (e.g., which may comprise part number L6382DTR, manufactured by ST Microelectronics). The forward converter 240 may comprise a transformer 220 and the inverter voltage V_{INV} may be coupled to the primary winding of the transformer 220 through a DC-blocking capacitor C216 (e.g., which may have a capacitance of approximately 0.047 μF), such that a primary voltage V_{PRI} may be generated across the primary winding.

The forward converter 240 may comprise a current sense circuit 218 (e.g., including a sense resistor R219) coupled in series with the half-bridge inverter (e.g., in series with the first FET Q210 and the second FET Q212). The current sense circuit 218 may generate a first sense signal V_{SENSE1} in response to a sense current I_{SENSE} conducted through the sense resistor R219 (e.g., conducted through the half-bridge inverter). The control circuit 250 may receive the first sense signal V_{SENSE1} and may be configured to determine the magnitude of the sense current I_{SENSE} of the forward converter 240 in response to the first sense signal V_{SENSE1}. The control circuit 250 may use the magnitude of the sense current I_{SENSE} to determine an input power P_{IN} of the forward converter 240. For example, the control circuit 250 may use the magnitude of the bus voltage V_{BUS} (e.g., which may be determined from the bus voltage feedback signal V_{BUS-FB} and/or stored in the memory 170) to calculate the input power P_{IN}, e.g., P_{IN}=V_{BUS}·I_{SENSE}.

The secondary winding of the transformer 220 may generate a secondary voltage V_{SEC} and may be coupled to the AC terminals of a rectifier bridge 224 (e.g., a full-wave diode rectifier bridge) for rectifying the secondary voltage generated across the secondary winding. The positive DC terminal of the rectifier bridge 224 may be coupled to the LED light source 202 through an output inductor L226 (e.g., an energy storage inductor, which may be located on the secondary side of the transformer and may have an inductance of approximately 400 μH), such that an inductor current I_{L226} may be conducted through the output inductor L226 and a load voltage V_{LOAD} may be generated across an output capacitor C228 (e.g., which may have a capacitance of approximately 3 μF). The transformer 220 may provide electrical isolation between the line voltage input of the LED driver 200 (e.g., the hot terminal and the neutral terminal N) and the LED light source 202.

The control circuit 250 may be configured to pulse-width modulate (PWM) the drive signals V_{DR1}, V_{DR2} to control the present intensity L_{PRES} of the LED light source 202 towards a target intensity L_{TRGT}, which may range from the low-end intensity L_{LE} to the high intensity L_{HE}. The control circuit 250 may be configured to adjust respective duty cycles DC₁, DC₂ of the drive signals V_{DR1}, V_{DR2} to adjust the present intensity L_{PRES}. Near the high-end intensity L_{HE}, the load regulation circuit 240 may operate in a continuous mode of operation. The continuous mode of operation may refer to a mode in which the inductor current I_{L226} may be continuous (e.g., the inductor current I_{L226} may be continuously above zero amps). Near the low-end intensity L_{LE}, the load regulation circuit 140 may operate in a discontinuous mode of operation. The discontinuous mode of operation may refer to a mode in which the inductor current I_{L226} may be discontinuous (e.g., the inductor current I_{L226} may reach approximately zero amps during at least a portion of an operating period of the drive signals V_{DR1}, V_{DR2}).

The control circuit 250 may receive a load-voltage feedback signal V_{V-LOAD} and/or a load-current feedback signal V_{I-LOAD} from the load sense circuit 260. The load sense circuit 260 may generate the load-voltage feedback signal V_{V-LOAD} and/or load-current feedback signal V_{I-LOAD} in response to a second sense signal V_{SENSE2} received from the load regulation circuit 240. For example, the second sense signal V_{SENSE2} may be generated across a winding 230 magnetically coupled to the output inductor L226 of the load regulation circuit 140 and may be representative of the magnitude of an inductor voltage V_{L226} generated across the output inductor. The winding 230 may be electrically isolated from the output inductor L226, and as such the load sense circuit 260 (and thus the line voltage input of the LED driver 200) may be electrically isolated from the load regulation circuit 240 (and thus the LED light source 202).

When the target intensity L_{TRGT} of the LED light source 202 is greater than a first threshold intensity L_{TH1} (e.g., approximately 60% of a maximum intensity of the lighting load), the control circuit 250 may be configured to determine the average magnitude I_{AVE} of the load current I_{LOAD} from the load-voltage feedback signal V_{V-LOAD} using a first load current measurement technique. The load sense circuit 260 may comprise a peak detect circuit 270 for generating the load-voltage feedback signal V_{V-LOAD} from the second sense signal V_{SENSE2}. When the FETs Q210, Q212 of the load regulation circuit 240 are non-conductive, the output inductor L226 is electrically coupled in parallel with the LED light source 202, and the magnitude of the inductor voltage V_{L226} may be approximately equal to the load voltage V_{LOAD}. When the FETs Q210, Q212 of the load regulation circuit 240 are non-conductive (e.g., when the magnitude of the inductor voltage V_{L226} may be approximately equal to the load voltage V_{LOAD}), a capacitor C272 may be configured to charge through a diode D274 and the winding 230 to the peak magnitude of the second sense signal V_{SENSE2}. Because of the orientation of the diode D274, a negative voltage V_{NEG} (e.g., voltage having a negative polarity) may be generated at the junction of the capacitor C272 and the diode D274. The negative voltage V_{NEG} may be received by an inverting amplifier 275 (e.g., an operational amp inverter), which may generate a positive voltage V_{POS} (e.g., a voltage having positive polarity). The positive voltage V_{POS} may be filtered by a resistor-capacitor (RC) filter circuit comprising a resistor R276 (e.g., having a resistance of approximately 12.1 kΩ) and a capacitor C278 (e.g., having a capacitance of approximately 1000 pF). The load-voltage feedback signal V_{V-LOAD} may be generated at the junction of the resistor R276 and the capacitor C278 and may have a magnitude (e.g., a DC magnitude) that is representative of the magnitude of the load voltage V_{LOAD}. The control circuit 250 may calculate the average magnitude I_{AVE} of the load current I_{LOAD} using the input power P_{IN} of the forward converter 240 (e.g., determined from the magnitude of the bus voltage V_{BUS} and the first sense signal V_{SENSE1}), the magnitude of the load voltage V_{LOAD} determined from the load-voltage feedback signal V_{V-LOAD}, and an efficiency η of the forward converter 240, e.g., I_{AVE}=(η·P_{IN})/V_{LOAD}, where η·P_{IN} may represent the output power P_{OUT} of the load control device.

When the target intensity L_{TRGT} of the LED light source 202 is less than a second threshold intensity L_{TH2} (e.g., approximately 40% of the maximum intensity of the lighting load), the control circuit 250 may be configured to determine the average magnitude I_{AVE} of the load current I_{LOAD} from the load-current feedback signal V_{I-LOAD} using a second load current measurement technique. The load sense circuit 260 may comprise an integrator circuit 280 and a filter circuit 282 (e.g., such as a boxcar filter circuit) for generating the load-current feedback signal V_{I-LOAD}. The integrator circuit 280 may integrate the second sense signal V_{SENSE2} and may generate an integrated signal V_{INT}, which may be approximately equal to or may be a scaled version of (e.g., a percentage of) the inductor current I_{L226}. For example, the integrator circuit 280 may comprise an operational amplifier integrator. Since the magnitude of the inductor voltage V_{L226} may be a function of the derivative of the inductor current I_{L226}, the integral of the second sense signal V_{SENSE2} may be approximately equal to or may be a scaled version of (e.g., a percentage of) the inductor current I_{L226}, where the scaling factor may be dependent upon a number of factors including the inductance of the output inductor L226, the number of turns of the winding 230, and/or the values of the components of the integrator circuit 280.

The average magnitude I_{AVE} of the load current I_{LOAD} may be approximately equal to the average magnitude I_{AVE} of the inductor current I_{L226}. The filter circuit 282 may be configured to filter the integrated signal V_{INT} to generate the load-current feedback signal V_{I-LOAD}, which may have a DC magnitude that is representative of the average magnitude I_{AVE} of the load current I_{LOAD}. The filter circuit 282 may operate to improve the performance of the load control device in various ways. For example, when the forward converter 240 is operating in the discontinuous mode (e.g., near the low-end intensity L_{LE}), the load current I_{LOAD} and/or the inductor current I_{L226} may reach approximately zero amps during at least a portion of the operating periods of the drive signals V_{DR1}, V_{DR2} (e.g., the inductor current I_{L226} and/or the load current I_{LOAD} may comprise one or more pulses in the discontinuous mode). The pulses of the load current I_{LOAD} (e.g., and thus pulses of the inductor current I_{L226}) may be far apart and the average magnitude I_{AVE} of the integrated signal V_{INT} may be so small that the control circuit 250 may not able to appropriately sample and/or measure the average magnitude I_{AVE} of the integrated signal V_{INT}. The filter circuit 282 may be configured to filter (e.g., only filter) the integrated signal V_{INT} during a filter window time period T_{FW} (e.g., a time window) around the pulses of the inductor current I_{L226}. The filter circuit 282 may comprise a controllable switching device (e.g., a controllable switch 284) that may be rendered conductive and non-conductive in response to a filter control signal V_{FC} generated by the control circuit 250. This way, the control circuit 250 may control the controllable switch 284 to selectively couple the integrated signal V_{INT} to a filter (e.g., an RC filter) comprising a resistor R286 (e.g., having a resistance of approximately 510Ω) and a capacitor C288 (e.g., having a capacitance of approximately 0.47 μF). The load-current feedback signal V_{I-LOAD} may be generated at the junction of the resistor R286 and the capacitor C288.

Since the control circuit 250 is generating the drive signals V_{DR1}, V_{DR2}, which cause the generation of the pulses of the inductor current I_{L226}, the control circuit 250 may generate the filter control signal V_{FC} to render the controllable switch 284 conductive and non-conductive in coordination with the drive signals V_{DR1}, V_{DR2}. For example, the control circuit 250 may drive the filter control signal V_{FC} high (e.g., towards the supply voltage V_{CC}) to render the controllable switch 284 conductive at approximately the same time as driving either of the drive signals V_{DR1}, V_{DR2} high. The control circuit 250 may maintain the filter control signal V_{FC} high for filter window time period T_{FW}, which may be at least as long as the length of each pulse of the inductor current I_{L226} (e.g., at least as long as the length of each pulse of the load current I_{LOAD}). At the end of the filter window time period T_{FW}, the control circuit 250 may drive the filter control signal V_{FC} low (e.g., towards zero volts) to render the controllable switch 284 non-conductive. The capacitor C288 may charge when the controllable switch 284 is conductive and may maintain the magnitude of the load-current feedback signal V_{I-LOAD} substantially constant when the controllable switch 284 is non-conductive. As a result, the magnitude of the load-current feedback signal V_{I-LOAD} may indicate an average magnitude I_{WIN} of the load current I_{LOAD} during (e.g., only during) the filter window when the filter control signal V_{FC} is high. The control circuit 250 may be configured to calculate the average magnitude I_{AVE} of the load current I_{LOAD} based on the average magnitude I_{WIN} of the load current I_{LOAD} during the filter window and a present duty cycle DC_{SW} of the filter control signal V_{FC}, e.g., I_{AVE}=DC_{SW}·I_{WIN}.

The filter control signal V_{FC} may be used to reset the integrator circuit 280 at the end of the filter window when the magnitude of the filter control signal V_{FC} is high. For example, the filter control signal V_{FC} may be coupled to the integrator circuit 280 via an inverter circuit 289, which may be configured to generate an inverted signal V_{INV}. When the filter control signal V_{FC} is driven low (e.g., towards circuit common) at the end of the filter window, the inverted signal V_{INV} may be driven high to reset the inverter circuit 280.

When the target intensity L_{TRGT} of the LED light source 2020 is less than or equal to the first threshold intensity L_{TH1} and greater than or equal to the second threshold intensity L_{TH2}, the control circuit 250 may be configured to use both of the load-voltage feedback signal V_{V-LOAD} and the load-current feedback signal V_{I-LOAD} to determine the average magnitude of the load current I_{LOAD}. For example, the control circuit 150 may be configured to appropriately mix the average magnitude of the load current I_{LOAD} determined from the load-voltage feedback signal V_{V-LOAD}, and the average magnitude of the load current I_{LOAD} determined from the load-current feedback signal V_{I-LOAD} (e.g., as will be described in greater detail below) to derive an estimated average magnitude of the load current I_{LOAD}.

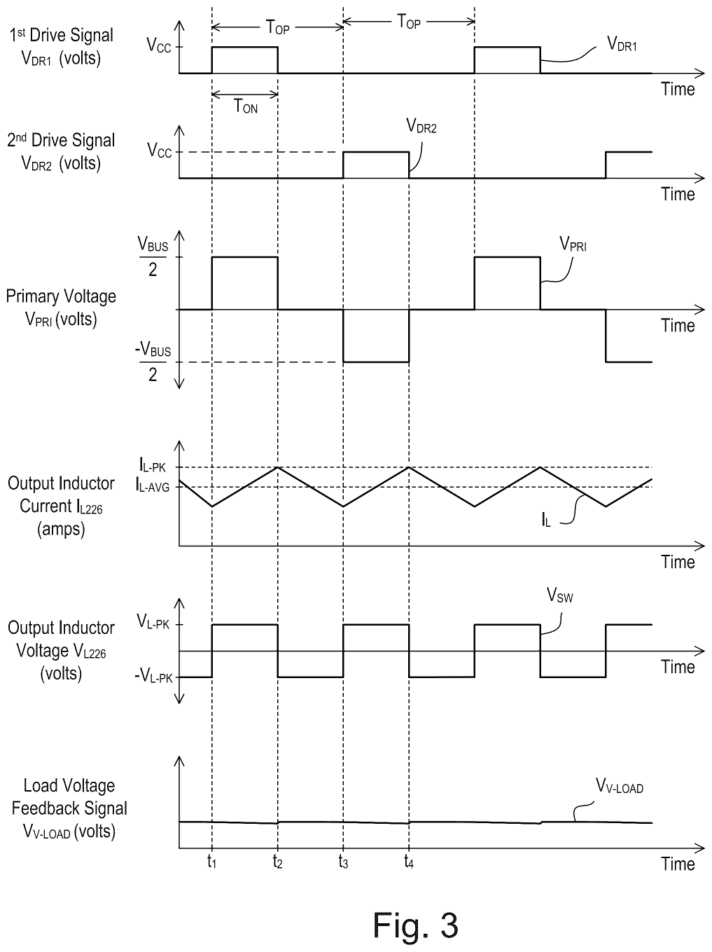

FIG. 3 is a diagram of simplified waveforms illustrating the operation of the LED driver 200 when the forward converter 240 is operating in the continuous mode of operation (e.g., near the high-end intensity L_{HE}). The drive signals V_{DR1}, V_{DR2} may be characterized by an operating frequency for and an operating period T_{OP}. During each period of the drive signals V_{DR1}, V_{DR2}, the control circuit 250 may drive one of the drive signals V_{DR1}, V_{DR2} high (e.g., towards the supply voltage V_{CC}) for an on-time T_{ON} (e.g., between times t₁ and t₂ in FIG. 3) to render the respective FET Q210, Q212 conductive for the on-time at different times (e.g., the FETs Q210, Q212 are conductive at different times). The control circuit 250 may then drive signal V_{DR1}, V_{DR2} low for the remainder of the period (e.g., between times t₂ and t₃ in FIG. 3). During the next period of the drive signals V_{DR1}, V_{DR2}, the control circuit 250 may drive the other one of the drive signals V_{DR1}, V_{DR2} high for the on-time T_{ON} (e.g., between times t₃ and t₄ in FIG. 3) to render the respective FET Q210, Q212 conductive for the on-time.

When the high-side FET Q210 is conductive, the bus voltage V_{BUS} may be coupled across the series combination of the capacitor C216 and the primary winding of the transformer 220 allowing the capacitor C216 to charge, such that the primary voltage V_{PRI} has a magnitude of approximately half of the magnitude of the bus voltage V_{BUS}. Accordingly, the magnitude of the primary voltage V_{PRI} across the primary winding of the transformer 220 may be equal to approximately half of the magnitude of the bus voltage V_{BUS} (e.g., V_{BUS}/2). When the low-side FET Q212 is conductive, the capacitor C216 may be coupled across the primary winding, such that the primary voltage V_{PRI} may have a negative polarity with a magnitude equal to approximately half of the magnitude of the bus voltage V_{BUS}.

When either of the high-side and low-side FETs Q210, Q212 are conductive, a secondary voltage V_{SEC} may be developed across the secondary winding of the transformer 220. Because the secondary winding of the transformer 220 is coupled to the output inductor L226 and the LED light source 202 through the rectifier bridge 224, the secondary voltage V_{SEC} may be produced across the series combination of the output inductor L226 and the LED light source 202 when either of the FETs Q210, Q212 are conductive. At this time, the magnitude of the inductor voltage V_{L226} may be at a peak magnitude V_{L-PK} and the magnitude of the output inductor current I_{L226} conducted by the output inductor L226 may increase with respect to time as shown in FIG. 3. When the FETs Q210, Q212 are non-conductive, the output inductor L226 may be coupled in parallel with the LED light source 202 and the magnitude of the inductor voltage V_{L226} may have a negative peak magnitude-V_{L-PK}. In addition, the magnitude of the inductor current I_{L226} may decrease in magnitude with respective to time when the FETs Q210, Q212 are non-conductive. Since the forward converter 240 is operating in the continuous mode, the magnitude of the inductor current I_{L226} does not reach zero amps (e.g., the magnitude of the inductor current I_{L226} is continuously above zero amps during respective operating periods of the drive control signals V_{DR1}, V_{DR2}). In the continuous mode, the operating period T_{OP} of the drive signals V_{DR} may be equal to a minimum operating period T_{MIN}. The inductor current I_{L226} may be characterized by a peak magnitude I_{L-PK} and an average magnitude I_{L-AVG}. The control circuit 250 may increase and/or decrease the on-time T_{ON} of the drive control signals V_{DR1}, V_{DR2} (e.g., and the duty cycle DC_{INV} of the inverter voltage V_{INV}) to respectively increase and decrease the average magnitude I_{L-AVG} of the output inductor current I_{L}, and thus respectively increase and decrease the intensity of the LED light source 202.

Near the high-end intensity L_{HE} (e.g., when the forward converter 240 is operating in the continuous mode of operation), the control circuit 250 may determine the average magnitude of the load current I_{LOAD} from the load-voltage feedback signal V_{V-LOAD} using the first load current measurement technique. When the FETs Q210, Q212 are rendered non-conductive (e.g., at times t₂ and t₄ in FIG. 3), the capacitor C272 of the peak detect circuit 270 may charge to the peak magnitude of the second sense signal V_{SENSE2} for generating the load-voltage feedback signal V_{V-LOAD} across the capacitor C278. When either of the FETs Q210, Q212 are conductive, the capacitor C278 may maintain the magnitude of the load-voltage feedback signal V_{V-LOAD} substantially constant (e.g., between times t₃ and t₄). The control circuit 250 may sample (e.g., periodically sample) the magnitude of the load-voltage feedback signal V_{V-LOAD} and calculate the average magnitude of the load current I_{LOAD}.

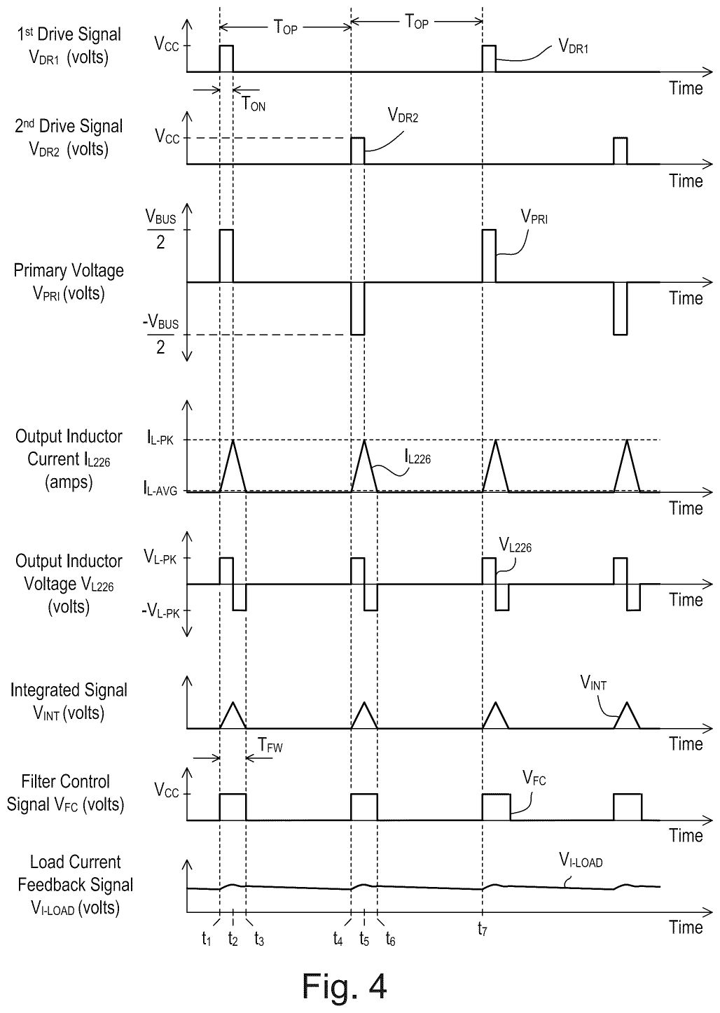

FIG. 4 is a diagram of simplified waveforms illustrating the operation of the LED driver 200 when the forward converter 240 is operating in the discontinuous mode of operation (e.g., near the low-end intensity L_{LE}). The control circuit 250 may generate the drive signals V_{DR1}, V_{DR2} with the operating period T_{OP} (e.g., the same operating period as in FIG. 3), but with a smaller length for the on-time T_{ON} (e.g., compared to the on-time in FIG. 3).

When either of the high-side and low-side FETs Q210, Q212 are conductive, the magnitude of the inductor voltage V_{L226} may be at the peak magnitude V_{L-PK} and the magnitude of the output inductor current I_{L226} conducted by the output inductor L226 may increase with respect to time (e.g., between times t₁ and t₂ and/or between times t₄ and t₅). When the FETs Q210, Q212 are non-conductive, the magnitude of the inductor voltage V_{L226} may be at the negative peak magnitude-V_{L-PK}, and the magnitude of the inductor current I_{L226} may decrease in magnitude with respective to time until the magnitude of the inductor current I_{L226} reaches approximately zero amps (e.g., between times t₂ and t₃ and/or between times t₅ and t₆). Since the forward converter 240 is operating in the discontinuous mode, the magnitude of the inductor current I_{L226} may be at approximately zero amps for the remainder of the present operating period T_{OP} (e.g., between times t₃ and t₄ and/or between t₆ and t₇). At the beginning of each period, the output inductor L226 may conduct a pulse of current (e.g., a triangular pulse), as shown in FIG. 4. Because the pulses of current may be spaced apart by larger amounts as the present intensity L_{PRES} is decreased towards the low-end intensity L_{LE}, the average magnitude I_{L-AVG} of the inductor current I_{L226} may become very small (e.g., much smaller than the peak magnitude I_{L-PK} of the inductor current I_{L226}).

Near the low-end intensity L_{LE} (e.g., when the forward converter 240 is operating in the discontinuous mode of operation), the control circuit 250 may determine the average magnitude of the load current I_{LOAD} (e.g., from the load-current feedback signal V_{I-LOAD}) using the second load current measurement technique. The integrator circuit 280 of the load sense circuit 260 may integrate the second sense signal V_{SENSE2} to generate the integrated signal V_{INT}, which may be equal to or may be a scaled version of the inductor current I_{L226} as shown in FIG. 4. Since the average magnitude I_{L-AVG} of the inductor current I_{L226} may be very small (e.g., close to approximately zero amps) near the low-end intensity L_{LE}, the control circuit 250 may be configured to generate the filter control signal V_{FC} to enable the filter circuit 282 to filter (e.g., only filter) the integrated signal V_{INT} during filter window time periods T_{FW} around the pulses of the inductor current I_{L226}. The control circuit 250 may generate the filter control signal V_{FC} in coordination with the drive signals V_{DR1}, V_{DR2}. For example, the control circuit 250 may generate the filter control signal V_{FC} as a pulse-width modulated signal having a period equal to or similar as the operating period T_{OP} of the drive signals V_{DR1}, V_{DR2}. The control circuit 250 may drive the magnitude of the filter control signal V_{FC} high at approximately the same time or slightly before the time at which either of the drive signals V_{DR1}, V_{DR2} is driven high (e.g., at times t₁ and t₄ in FIG. 4). For example, the filter window time periods T_{FW} of the filter control signal V_{FC} may each be approximately equal to twice the on-time T_{ON} of the drive signals V_{DR1}, V_{DR2}. In addition, the filter window time periods T_{FW} of the filter control signal V_{FC} may each be longer than twice the on-time T_{ON} of the drive signals V_{DR1}, V_{DR2}, for example, up to approximately the minimum operating period T_{MIN} of the drive signals. The control circuit 250 may drive the magnitude of the filter control signal V_{FC} low at the ends of the filter window time periods T_{FW} (e.g., at times t₃ and to in FIG. 4). When the filter control signal V_{FC} is high, the filter circuit 282 may be configured to filter the integrated signal V_{INT} to generate the load-current feedback signal V_{I-LOAD}. When the filter control signal V_{FC} is low (e.g., between times t₃ and t₄), the capacitor C288 of the filter circuit 280 may maintain the magnitude of the load-current feedback signal V_{I-LOAD} substantially constant (e.g., the magnitude of the load-current feedback signal V_{I-LOAD} between times t₃ and t₄ may be substantially similar to the magnitude of the load-current feedback signal V_{I-LOAD} between times t₁ and t₂). The control circuit 250 may sample (e.g., periodically sample) the magnitude of the load-current feedback signal V_{I-LOAD} to determine the average magnitude of the load current I_{LOAD}.

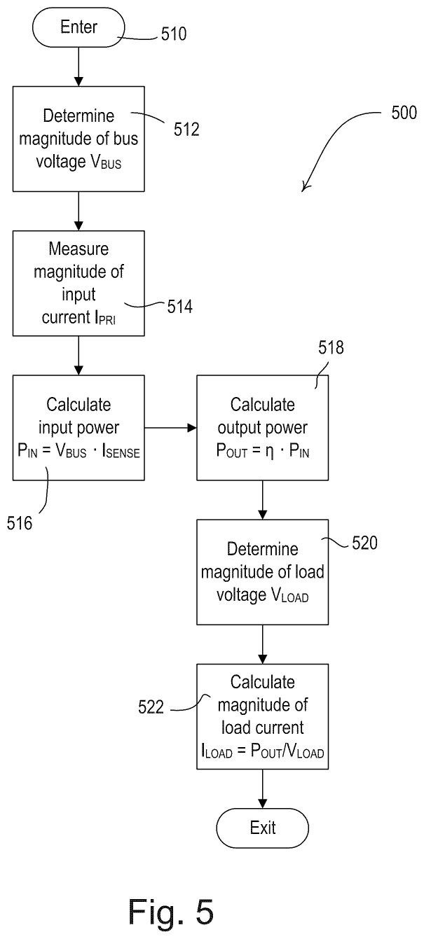

FIG. 5 is a simplified example flowchart of a first load current measurement procedure 500 that may be executed by a control circuit of a load control device (e.g., the control circuit 150 of the LED driver 100 and/or the control circuit 250 of the LED driver 200) for controlling an electrical load (e.g., an LED light source, such as the LED light source 202). For example, the control circuit 250 may execute the first load current measurement procedure 500 to determine an average magnitude of a load current conducted through the electrical load (e.g., the load current I_{LOAD} described herein) using a first load current measurement technique. The load control device may comprise a load regulation circuit (e.g., the load regulation circuit 140 and/or the forward converter 240), which may in turn comprise an output inductor. The output inductor may be magnetically coupled to a winding for generating a sense voltage that may be used to generate a load-voltage feedback signal. The load-voltage feedback signal may have a magnitude representative of the magnitude of a load voltage generated across the electrical load (e.g., the load-voltage feedback signal V_{V-LOAD}).

The control circuit may execute the first load current measurement procedure 500, for example, periodically at 510 (e.g., when a target power level of the electrical load is above a high threshold). In addition, the first load current measurement procedure 500 may be executed as part of another load current measurement procedure. At 512, the control circuit may determine the magnitude of the bus voltage V_{BUS}. For example, the control circuit 250 may determine the magnitude of the bus voltage V_{BUS} from the bus voltage feedback signal V_{BUS-FB} at 512. In addition, the control circuit 250 may recall a target bus voltage (e.g., for controlling the bus voltage control signal V_{BUS-CNTL}) from memory at 512 to use as the magnitude of the bus voltage V_{BUS}. At 514, the control circuit may determine the magnitude of the sense current I_{SENSE}. (e.g., shown in FIG. 2). For example, the control circuit 250 may determine the magnitude of the sense current I_{SENSE} at 514 from the first sense signal V_{SENSE1} generated by the current sense circuit 218 when the second FET Q212 is conductive. At 516, the control circuit may calculate the input power P_{IN} of the load control device using the determined magnitude of the bus voltage V_{BUS} and the determined magnitude of the sense current I_{SENSE}, e.g., P_{IN}=V_{BUS}. I_{SENSE}.

At 518, the control circuit may calculate the output power P_{OUT} of the load control device using the calculated input power P_{IN} and an efficiency η of the power regulation circuit. For example, the efficiency η may be a predetermined value stored in memory (e.g., the memory 170). At 520, the control circuit may determine the magnitude of the load voltage V_{LOAD}, e.g., by sampling and processing (e.g., scaling) the load-voltage feedback signal V_{V-LOAD}. At 522, the control circuit may calculate the magnitude of the load current I_{LOAD} using the calculated output power P_{OUT} and the determined load voltage V_{LOAD}, e.g., I_{LOAD}=P_{OUT}/V_{LOAD}, before the first load current measurement procedure 500 exits.

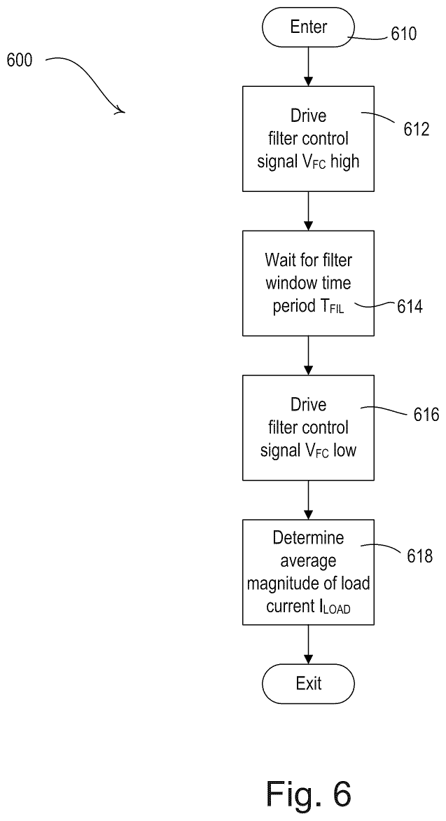

FIG. 6 is a simplified example flowchart of a second load current measurement procedure 600 that may be executed by a control circuit of a load control device (e.g., the control circuit 150 of the LED driver 100 and/or the control circuit 250 of the LED driver 200) for controlling an electrical load (e.g., an LED light source, such as the LED light source 202). For example, the control circuit 250 may execute the second load current measurement procedure 600 to determine an average magnitude of a load current of the electrical load (e.g., the load current I_{LOAD} described herein) using a second load current measurement technique. The load control device may comprise a load regulation circuit (e.g., the load regulation circuit 140 and/or the forward converter 240) which may in turn comprise an output inductor. The output inductor may be magnetically coupled to a winding for generating a sense voltage that may be used to generate a load-current feedback signal. The load-current feedback signal may have a magnitude representative of the magnitude of a load current conducted through the electrical load (e.g., the load-current feedback signal V_{I-LOAD}).

The control circuit may execute the second load current measurement procedure 600, for example, periodically at 610 (e.g., when a target power level of the electrical load is below a low threshold). In addition, the second load current measurement procedure 600 may be executed as part of another load current measurement procedure. At 612, the control circuit may drive a filter control signal (e.g., the filter control signal V_{FC}) high to enable a filter circuit (e.g., a boxcar filter circuit) to adjust the magnitude of the load-current feedback signal. At 614, the control circuit may wait for a time period (e.g., the filter window time period T_{FW} as shown in FIG. 4), before driving the filter control signal low to disable the filter circuit from adjusting the magnitude of the load-current feedback signal at 616. At 618, the control circuit may determine the average magnitude of the load current I_{LOAD}, e.g., by sampling and processing (e.g., scaling) the magnitude of the load-current feedback signal V_{I-LOAD}.

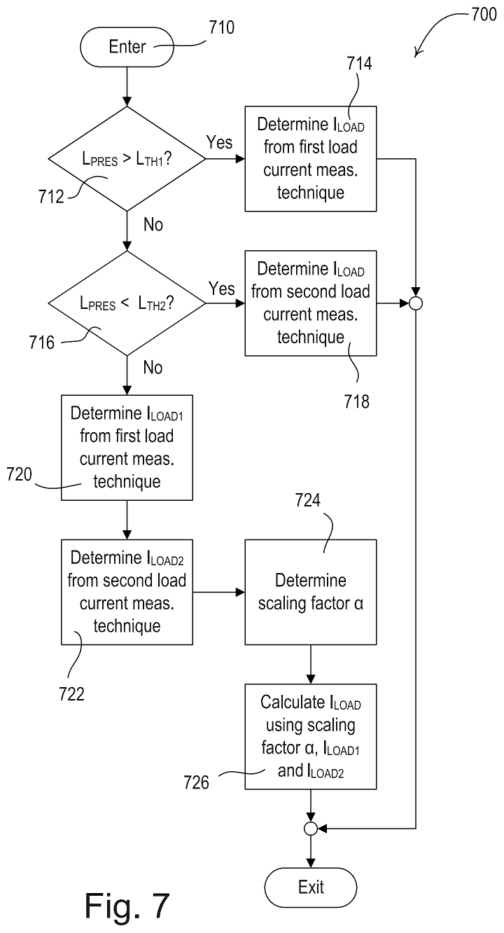

FIG. 7 is a simplified flowchart of a third load current measurement procedure 700 that may be executed by a control circuit of a load control device (e.g., the control circuit 150 of the LED driver 100 and/or the control circuit 250 of the LED driver 200) for controlling an electrical load (e.g., an LED light source, such as the LED light source 202). For example, the control circuit may execute the third load current measurement procedure 600 to determine an average magnitude of a load current of the electrical load (e.g., the load current I_{LOAD} described herein) using multiple load current measurement techniques (e.g., using the first and second load current measurement procedures 500, 600 shown in FIGS. 5 and 6). The load control device may comprise a load regulation circuit (e.g., the load regulation circuit 140 and/or the forward converter 240).

The control circuit may execute the third load current measurement procedure 700, for example, periodically at 710. For example, if the present intensity L_{PRES} of the LED light source is greater than a first threshold intensity L_{TH1} (e.g., approximately 60% of a maximum intensity of the LED light source) at 712, the control circuit may determine the average magnitude of the load current I_{LOAD} using a first load current measurement technique at 714, for example, by executing the first load current measurement procedure 500 (e.g., as shown in FIG. 5). If the present intensity L_{PRES} of the LED light source is less than a second threshold intensity L_{TH2} (e.g., approximately 40% of the maximum intensity of the LED light source) at 716, the control circuit may determine the average magnitude of the load current I_{LOAD} using a second load current measurement technique at 718, for example, by executing the second load current measurement procedure 600 (e.g., as shown in FIG. 6).

If the present intensity L_{PRES} of the LED light source is less than or equal to the first threshold intensity L_{TH1} at 712 and greater than or equal to the second threshold intensity L_{TH2} at 716 (e.g., if the present intensity L_{PRES} of the LED light source is between the first threshold intensity L_{TH1} and the second threshold intensity L_{TH2}), the control circuit may use both of the first and second load current measurement techniques and combine the values (e.g., scaled versions of the values) determined from the first and second load current measurement techniques to determine the average magnitude of the load current I_{LOAD}. For example, the control circuit may determine a first value I_{LOAD1} for the average magnitude of the load current I_{LOAD} using the first load current measurement technique at 720, and determine a second value I_{LOAD2} for the average magnitude of the load current I_{LOAD} using the second load current measurement technique at 722. At 724, the control circuit may determine a scaling factor α for calculating the average magnitude of the load current I_{LOAD}. For example, the first and second values I_{LOAD1}, I_{LOAD2} may be blended (e.g., linearly blended) together between the first and second threshold intensities L_{TH1}, L_{TH2}. The scaling factor α may represent a percentage distance of the present intensity L_{PRES} between the first and second threshold intensities L_{TH1}, L_{TH2}, e.g.,

$$α = ( {L}_{PRES} - {L}_{TH 2} ) / ( {L}_{TH 1} - {L}_{TH 2} ) .$$

At 726, the control circuit may calculate the average magnitude of the load current I_{LOAD} based on two components derived using the first and second load current measurement techniques and by applying the scaling factor α to those components, e.g.,

$${I}_{LOAD} = α \cdot {I}_{LOAD 1} + ( 1 - α ) \cdot {I}_{LOAD 2}$$

where α·I_{LOAD1} and (1−α)·I_{LOAD2} may represent respective portions of I_{LOAD1}, I_{LOAD2} used to calculate the average magnitude of the load current I_{LOAD}. After determining the average magnitude of the load current I_{LOAD} at 714, 718, or 726, the third load current measurement procedure 700 may exit.

Although described with reference to an LED driver, one or more embodiments described herein may be used with other load control devices. For example, one or more of the embodiments described herein may be performed by a variety of load control devices that are configured to control of a variety of electrical load types, such as, for example, a LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, controllable circuit breaker, or other switching device for turning electrical loads or appliances on and off; a plug-in load control device, controllable electrical receptacle, or controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or computer monitor; a power supply; an audio system or amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

1. An electric load controller, comprising:
controller circuitry to:
determine whether a received target intensity is either greater than a first threshold intensity or less than a second threshold intensity;
responsive to the determination that the received target intensity exceeds the first threshold intensity:
determine an average load current supplied to the LED lighting load using a load voltage feedback signal generated using an inductor coupled to the power input to the LED lighting load; and
responsive to the determination that the received target intensity is less than the second threshold intensity:
determine the average load current using a load current feedback signal by integrating the load voltage feedback signal generated by a discontinuous current supplied to the LED lighting load.
